(19) United States
(12) Patent Application Publication
(10) Pub. No.: US 2006/0225850 A1
(43) Pub. Date: Oct. 12, 2006

(54) Rolling door

(76) Inventor: Hugo Schweitzer, Herscheid (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/550,171

(22) PCT Filed: Jun. 1, 2003
(86) PCT No.: PCT/EP03/06261

§ 371 Date: Sep. 20, 2005

(30) Foreign Application Priority Data
Mar. 20, 2003 (EP) 03006238.4
Apr. 11, 2003 (DE) 203 05 922.0

(51) Int. Cl. E06B 9/56

(52) U.S. Cl. 160/310

(57) ABSTRACT

A rolling door with at least one closing element and an elastically deformable stabilization element is described herein. The closing element, a strip-like and/or web-like hanging element, is positioned in a region around the lower edge of the rolling door when the rolling door is in the closed position. The elastically deformable stabilization element is arranged on the lower edge of the closing element and exhibits a restoring force which acts against a deformation of the stabilization element in a direction opposite to the closing direction when the rolling door is in a closed position. The restoring force of the stabilization element is less than a second restoring force which acts against a deformation of the stabilization element in a transversal or radial direction, more particularly, in a direction approximately perpendicular to the closing element in the closing direction.

The invention relates to a roll-up door comprising a closing element which is provided in the form of a strip-like hanging element at least in the region of a lower edge thereof when in the closed position, and an elastically deformable stabilizing element which is situated on the lower edge of the closing element when in the closed position.

Roll-up doors of this type are used in particular for closing hall entries. During the transition from the closed position to the open position, the closing element may be wound on a winding shaft situated above the hall entry, thereby ensuring compact accommodation of the closing element in the open position. For this purpose, the closing element in the form of an armored slat may be provided with multiple slats connected to one another in an articulated manner with respect to articulated axes running perpendicular to the direction of motion of the closing element. In cases for which rapid opening of the entry is more important than closing the entry in an intrusion-proof manner, the closing element may also be provided in the form of a strip-like hanging element, for example composed of PVC. To facilitate the opening motion, generally a counterweight device is used by which the closing element is pushed upward from the closed position in the direction of the open position. Such a counterweight device may absorb energy released during the closing motion of the closing element, which later is available for facilitating the opening motion. Such counterweight devices may be implemented in the form of spring systems, in particular tension spring and or torsion spring systems, which are stretched during the closing motion and relaxed again during the opening motion. Alternatively or additionally, the counterweight devices may also have weights which are raised during the closing motion and lowered again during the opening motion.

In the dimensioning of the counterweight device, particularly for roll-up doors having a closing element in the form of a strip-like hanging element, care must be taken that at the beginning of the closing motion a considerable breakaway torque of the drive must initially be overcome, whereas afterwards only a comparatively small torque is necessary for continuing the opening motion. This breakaway torque is typically 15 Nm or greater, whereas for continuing the motion a torque of only 2 to 3 Nm is usually required. Consequently, the counterweight device must be dimensioned so that it provides a sufficiently high breakaway torque. During the opening motion, the closing element is accelerated according to the breakaway torque, and upon reaching the open position must be appropriately decelerated to avoid damage to the drive, the closing element, and or the winding shaft.

Alternatively, the referenced elements may also be dimensioned in such a way that damage also does not occur when the opening motion abruptly stops. However, both of the above-described possibilities require great complexity of design to avoid damaging the roll-up door. To solve this problem, roll-up doors are proposed in DE 202 04 637 in which the counterweight device has at least one compensating element by which the closing element in the closed position is pushed into the open position, and which again decelerates the opening motion when the open position is reached. The disclosure of the referenced document with respect to the design of the counterweight devices is hereby explicitly incorporated by reference into the present description.

When roll-up doors having a closing element in the form of a strip-like hanging element are used, a stabilizing element is usually provided on the lower edge of the strip-like hanging element. On the one hand, this stabilizing element stabilizes the shape of the lower edge of the strip-like hanging element to ensure a defined closure by the closing element. On the other hand, the stabilizing element is used to facilitate the closing motion. For conventional roll-up doors, the stabilizing element is implemented in the form of a rod fastened to the lower edge of the strip-like hanging element.

As described above, roll-up doors having a closing element in the form of a strip-like hanging element are used in particular when a rapid opening and closing motion is important. In this case, fastening the stabilizing element to the lower edge of the strip-like hanging element during the closing motion entails considerable risk of injury if during the closing motion the stabilizing element strikes a person standing in the entry. Furthermore, as a result of the stabilizing elements, conventional roll-up doors may also damage objects during the closing motion. Lastly, when conventional stabilizing elements are used the hanging element itself and/or the guide elements for guiding the motion of the hanging element may be damaged if a vehicle strikes the hanging element in the closed position.

In light of these problems with conventional roll-up doors, it has previously been proposed to replace the stabilizing element, usually implemented in the form of a rigid rod, with a loop, formed by folding the lower edge of the hanging element upon itself, filled with sand. Filling the lower edge of the hanging element with sand facilitates triggering of the closing motion, and prevents injury and damage during the closing motion due to the flexibility of the sand filling. Furthermore, this sand filling may also prevent damage to the hanging element and or the guide elements when an object strikes the hanging element in the closed position. However, in this refinement of conventional roll-up doors, the original intended function for the stabilizing element, namely, ensuring a specified shape of the lower edge of the strip-like hanging element, is no longer achieved.

In view of these problems, in the prior art a refinement of known roll-up doors is described in DE 202 04 637, which is essentially characterized in that the stabilizing element is elastically deformable. Such a design of the stabilizing element on the one hand provides flexibility of the stabilizing element when objects or persons are struck, and on the other hand returns the stabilizing element, and therefore the lower edge of the closing element as well, to a predetermined shape. Altogether, the risk of damage or injury to objects or persons present in the entry is thereby eliminated, and a specified closure in the closed position is ensured.

For the known roll-up doors, it is considered especially practical for the stabilizing element to have a spring element, in particular a spring element which winds spirally around a helical axis running parallel to the lower edge of the strip-like hanging element. Obtaining a specified shape of the lower edge may thus be reliably ensured if the spring element is pretensioned to increase the restoring force when deformation occurs. The risk of damage or injury may be further reduced if the stabilizing element, implemented in the form of a spring element, for example, is enclosed at least partially by a layer of flexible material. The stabilizing element for the roll-up door known from the cited document may be accommodated in a loop formed on a lower edge of the strip-like hanging element, it being particularly practical from a structural design standpoint for the lower edge of the strip-like hanging element to fold back upon itself to form the loop.

To increase the operational reliability of the known devices, at least one guide member which cooperates with the guide element may be provided on at least one lateral edge of the closing element. If the guide member is disengaged from the guide element by collision of an object or vehicle with the closing element when in the closed position, reliable guiding of the motion of the closing element may be ensured by providing an intake system on the upper edge of the guide element by which the guide member may be automatically inserted into the guide element during a closing motion of the closing element.

The use of elastically deformable stabilizing elements on the lower edge of the closing elements of known roll-up doors can largely eliminate damage or injury to objects or persons present in the entry. However, it has been shown that with these stabilizing elements, which are advantageous with respect to reduction of injury or damage, the achievable stabilization of the closing element in the closed position is inadequate under wind load and the like. In view of these problems in the prior art, the object of the invention is to provide a roll-up door by which, on the one hand, damage or injury to objects or persons present in the entry can be largely eliminated, and on the other hand, sufficient stability of the closing element in the closed position is still achievable.

According to the invention, this object is achieved by a refinement of known roll-up doors which is essentially characterized in that the restoring force counteracting a deformation of the stabilizing element in a direction opposite to the closing direction is less than the restoring force counteracting a deformation of the closing element in a direction transverse, in particular approximately perpendicular, to the closing element when in the closed position.

The low restoring force when deformation occurs in a direction opposite to the closed position satisfactorily reduces the risk of damage or injury, whereas the higher restoring force in a direction transverse thereto ensures a good stabilizing function in this direction.

For obtaining different restoring forces, the stabilizing element may have at least one spring element having an asymmetrical, in particular oval, elliptical, or rectangular, cross section in an intersection plane running perpendicular to the lower edge of the closing element, the spring element in a direction perpendicular to the closing element in the closed position having a greater thickness than in a direction running in the closing direction. Additionally or alternatively, the stabilizing element may have at least two adjacent spring elements in a direction perpendicular to the closing element in the closed position in order to achieve a particularly high restoring force in-this direction.

An elastically deformable stabilizing element may be implemented with a particularly simple design in the form of a spring bar.

Within the scope of the invention, however, it has turned out to be particularly practical for the stabilizing element to be composed at least partially of an elastomeric material and/or plastic. Through the skillful choice of the cross-sectional shape of the stabilizing element formed from an elastomeric material, the different restoring forces in a direction opposite to the closing direction and in a direction transverse thereof may be adjusted in a particularly simple manner.

The use of a stabilizing element composed of an elastomeric material and/or a flexible plastic results in a particularly low risk of injury to persons. Furthermore, the risk of damage to objects is reduced. This is particularly true in comparison to conventional metal subdivisions.

The use of stabilizing elements composed of an elastomeric material and/or plastic may also result in optimal conditions when setting the roll-up door in motion, since no damages or scraping marks can be produced, as is observed when stabilizing elements made of aluminum, for example, are used. According to a further embodiment of the invention, for obtaining different restoring forces the stabilizing element may also have at least one leaf spring having primary surfaces oriented perpendicularly to the closing direction. For design and safety reasons it is particularly preferred for these leaf springs to be embedded in the elastomeric material. By providing two parallel leaf springs separated at a distance from one another, preferably with both embedded in an elastomeric material, it is possible to achieve a particularly high restoring force in a direction transverse to the closing direction while simultaneously ensuring a sufficiently low restoring force in a direction opposite to the closing direction.

Additionally or alternatively, reinforcing wires as used in the manufacture of synchronous belts, reinforcing belts, or the like may be incorporated into the stabilizing element.

The stabilizing element used for the roll-up door according to the invention may be fastened to the closing element in a particularly simple manner when the stabilizing element has a groove, situated at its upper edge and extending in the longitudinal direction of the stabilizing element, which at least partially accommodates a lower edge of the hanging element. The lower edge of the hanging element may be glued to and/or screwed into the groove to achieve a particularly secure attachment of the stabilizing element to the lower edge of the hanging element.

For roll-up doors according to the invention, the risk of injury and/or damage to objects or persons present in the entry, and the risk of damage to the roll-up door itself, is reduced by providing an elastically deformable stabilizing element. The risk of damage and/or injury may be further reduced by providing a safety device for the closing element which can be operated for switching off and/or triggering a change in direction of a drive device coupled to the closing element, thereby reliably preventing overload of the drive device and sustained impingement of force on objects or persons present in the entry.

In one particularly preferred embodiment of the invention, the safety device has a transmitting element that can be operated for sending wirelessly transmittable signals and a receiving element that can be operated for receiving the wirelessly transmitted signals, the transmitting element and/or receiving element preferably being situated in a channel passing through the stabilizing element. In one preferred embodiment of the invention, the channel used for accommodating the safety device is provided in the region of the lower edge of the stabilizing element. Additionally or alternatively, however, the channel for the safety device may be situated centrally or on the upper edge of the stabilizing element. Positioning in the region of the upper edge of the stabilizing element is preferred when there is a risk that the stabilizing element is exposed to floor moisture in the closed position of the roll-up door.

Within the scope of the invention, it has proven to be practical for the stabilizing element to have a multi-part design, a channel for accommodating a safety device preferably passing through at least one of the parts of the stabilizing element. This part of the stabilizing element may be designed to clip in below the profile, making it possible to economically replace the corresponding part of the stabilizing element if the channel is damaged.

Within the scope of the invention, it is also conceivable to provide a receptacle on the stabilizing element, which allows commercially available safety devices or contact bars to be fixed in place. For all embodiments of the invention in which a canal for accommodating a safety device is provided in the stabilizing element, use may be made of a deformation of the stabilizing element in the region of the channel for interrupting the transmission path of wirelessly transmitted signals from the transmitting element of the safety device to the receiving element of the safety device, so that this interruption may be employed to trigger the switching off or reversal of direction of the drive device. In one particularly preferred embodiment of the invention, the safety device has a photoelectric barrier having a transmitting element inserted into the channel of the stabilizing element, and a receiving element that is likewise inserted into the channel of the stabilizing element. In this particularly preferred embodiment of the invention, on the one hand the stabilizing element may cause the signal transmission path to be interrupted, and on the other hand the stabilizing element accommodating the receiving element and the transmitting element also reliably protects the safety device from damage.

For a multi-part design of the stabilizing element, the stabilizing element may also have receptacles for fixing in place sealing lips or sealing strips, which are optionally clipped into these receptacles in a particularly simple manner. This embodiment is of interest when the floor is very uneven and must be compensated for. In addition to or as an alternative to clippable sealing lips or sealing strips, it is also possible to provide fastening bars on one of the parts of the stabilizing element, onto which the corresponding sealing lips or sealing strips may be pushed.

As an additional advantage of a multi-part design of the stabilizing element, it is noted that such a design allows a particularly low height for the stabilizing element. In this case, only a slight drop requirement for the door is necessary. Furthermore, the multi-part design of the stabilizing element also permits roll-up doors to be economically and easily manufactured.

For conventional roll-up doors, the motion of the strip-like hanging element is usually guided with the assistance of guide elements in the form of guide rails provided on the lateral edge of the closing element. The lower edge of the strip-like hanging element unrolled from the winding during the closing motion engages with these guide rails. The closing motion is then guided with the assistance of the lateral edges of the hanging element which are accommodated in the guide rails. To reliably introduce the lower edge of the hanging element into the guide rail, an intake system is usually provided on the lower edge of the guide element by which the lateral edge of the closing element may be automatically introduced into the guide element during a closing motion. For conventional roll-up doors, this intake system is implemented by funnel-shaped extensions on the upper edge of the guide rails. However, it has been shown that, in particular for rapidly moving roll-up doors having stabilizing elements situated on the lower edge of the hanging element, in some cases despite use of the known intake systems malfunctions occur in which the hanging element is not introduced in the desired form into the guide rails.

According to a further aspect of the invention, this problem is solved by a refinement of known roll-up doors which is essentially characterized in that the intake system on the upper edge of the guide elements has at least two oppositely situated delimiting surfaces for the closing element, and/or pretensioning devices which may be provided on a stabilizing element situated on the lower edge thereof, by which the closing element, i.e., the stabilizing element, is pushed in directions opposite to and transverse to the direction of motion of the closing element.

Such intake systems achieve a centering of the lower edge of the closing element. This centering is dynamically designed so that for undesirably high deflections in one direction or the other, correspondingly high restoring forces are produced by the pretensioning devices, which are then acted on. By dynamic design of the intake system it is possible to ensure that the lower edge of the closing elements is reliably introduced into the guide elements, even at high closing speeds. In one particularly preferred embodiment of the invention, at least one pretensioning device has at least one bristle element which in the no-load state extends approximately perpendicularly to the closing element when in the closed position, and which may be elastically deflected by the closing element or stabilizing element which runs against it, the deflection of the bristle element producing a pretensioning force which is oriented transversely to the closing direction or motion of direction of the closing element and which acts on the closing element, i.e., stabilizing element.

Appropriate placement of the leaf springs optionally embedded in the stabilizing element causes the stabilizing element to tip by approximately 90° when it travels from the open position, and then to be pushed from the guides without damage. Under wind pressure the stabilizing element remains stable in the lateral guide rails of the roll-up door.

The invention is explained with reference to the drawing, to which express reference is made with respect to all particulars which are essential to the invention and which are not emphasized in greater detail. In the drawing,

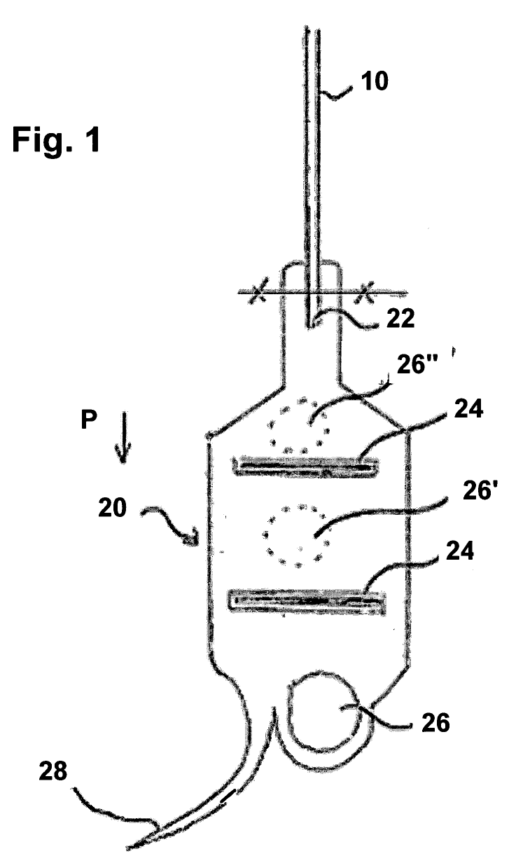

FIG. 1 shows a first schematic sectional illustration of a roll-up door according to the invention; and

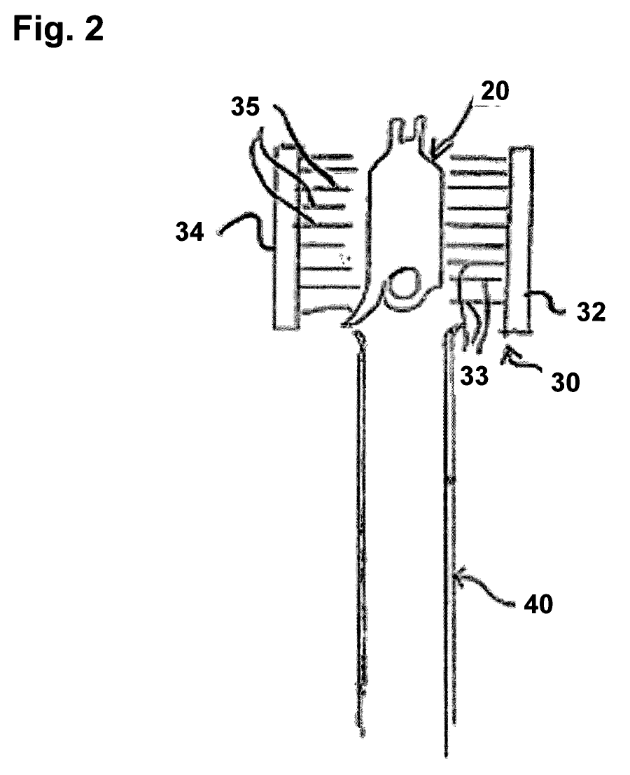

FIG. 2 shows a second schematic sectional illustration of a roll-up door according to the invention.

The roll-up door illustrated in FIG. 1 comprises a strip-like hanging element 10, on the lower edge of which a stabilizing element 20 is situated. The stabilizing element 20 has a groove 22 at its upper edge in which the lower edge of the hanging element 10 is accommodated. For securely fastening the stabilizing element 20 to the lower edge of the hanging element 10, the hanging element 10 may be glued to and/or screwed into the groove 22. Overall, the stabilizing element 20 has a greater thickness in a direction perpendicular to the closing direction of the hanging element 10, indicated by the arrow P, than in the closing direction itself. The overall stabilizing element 20 is essentially composed of an elastomeric material. In the embodiment of the invention illustrated in the drawing, the restoring force counteracting a deformation of the stabilizing element 20 in a direction opposite to the closing direction is less than the restoring force counteracting a deformation of the stabilizing element in a direction transverse, in particular approximately perpendicular, to the closing element when in the closed position. This characteristic of the stabilizing element 20 is achieved by embedding in the stabilizing element 20, which is made essentially of an elastomeric material, two leaf springs 24 whose primary surfaces run approximately perpendicular to the closing direction P to ensure a particularly low restoring force for deformation in a direction opposite to the closing direction, and to produce a particularly high restoring force when the stabilizing element is deformed in a direction perpendicular to the closing direction. The leaf springs 24 are embedded in the stabilizing device 20 approximately parallel and at a distance to one another so that, while a high restoring force is guaranteed in a direction perpendicular to the closing direction, a comparatively low restoring force is ensured for deformation in a direction opposite to the closing direction.

In the stabilizing element 20 illustrated in FIG. 1, a channel 26 running in the longitudinal direction of the stabilizing element passes through the stabilizing element at its lower edge. This channel 26 is used for accommodating a safety device, implemented in the form of a photoelectric barrier, for example, by which the switching off or reversal of direction of a drive device coupled to the closing element is triggered for a deformation of the lateral surface of the stabilizing element 20 which adjoins the channel 26.

Within the scope of the invention, it is also conceivable to situate the channel for accommodating the safety device centrally or on the upper edge of the stabilizing element, as indicated in FIG. 1 by 26′ or 26″, respectively.

Lastly, the stabilizing element illustrated in FIG. 1 also has a sealing lip 28 which projects forward and downward and which achieves sealing contact with the floor of the space to be closed by the closing element when the closed position is reached.

This sealing lip may also be designed as a separate part of the stabilizing element which may be clipped into a corresponding receptacle and/or pushed onto a corresponding fastening bar.

FIG. 2 schematically shows an intake system 30 according to the invention for the roll-up door described with reference to FIG. 1. The intake system 30 automatically threads the lower edge of the closing element during a closing motion into a guide rail 40 situated on a lateral edge of the opening to be closed by the closing element. To this end, the intake system 30 has two support elements 32 and 34 situated on opposite sides of the closing element. Starting with these support elements 32 and 34, a plurality of pretensioning elements extends in the direction of the hanging element, i.e., the stabilizing element 20. When the stabilizing element 20 strikes the bristles 33 or 35, the bristles are deflected, thereby producing a restoring force which acts on the stabilizing element 20 and is aligned transversely thereto.

The restoring force exerted on the stabilizing element 20 by the bristles 33 causes the stabilizing element 20 in FIG. 2 to be pushed to the left, while the stabilizing element is pushed to the right in the drawing by the restoring forces of the bristles 35. Overall, the restoring forces from the bristles 33 and 35 produce a centering of the stabilizing element 20. As a result of this centering, the stabilizing element 20 is reliably threaded into the upper edge of the guide rail 40.

The invention is not limited to the exemplary embodiments described with reference to the drawing. Rather, it is also conceivable for the pretensioning device to be implemented in another manner than by bristle elements. Furthermore, the stabilizing element may also be furnished with fewer or more than two leaf springs. It is also conceivable to achieve the desired distribution of the restoring forces solely by the appropriate choice of the cross-sectional shape of the stabilizing element.

1-13. (canceled)

14. A roll-up door, comprising:
at least one closing element having at least a closed position; and
an elastically deformable stabilizing element coupled to at least one lower edge of a
closing element, said stabilizing element configured to exert a first restoring force to counteract a deformation of said stabilizing element in a direction opposite to a closing direction when each of said at least one closing element is in said closed position and to exert a second restoring force to counteract a deformation of said stabilizing element in a direction transverse to each of said at least one closing element when each of said at least one closing element is in said closed position, said first restoring force being less than said second restoring force.

15. The roll-up door according to claim 14, wherein the stabilizing element is composed at least partially of an elastomeric material and/or plastic.

16. The roll-up door according to claim 14, wherein the stabilizing element has at least one leaf spring having primary surfaces, wires, and/or belts, oriented perpendicularly to the closing direction.

17. The roll-up door according to claim 16, wherein the at least one leaf spring is embedded in an elastomeric material.

18. The roll-up door according to claim 16, wherein the stabilizing element has two or more parallel leaf springs spatially separated from each other.

19. The roll-up door according to claim 14, wherein the stabilizing element comprises a groove situated at an upper edge of the stabilizing element and extending in a longitudinal direction of the stabilizing element, which at least partially accommodates a lower edge of one of the at least one closing element.

20. The roll-up door according to claim 19, wherein said lower edge is glued to and/or screwed into the groove.

21. The roll-up door according to claim 19, wherein the stabilizing element comprises at least one channel passing through the stabilizing element.

22. The roll-up door according to claim 21, further comprising a safety device, accommodated in the channel, which can be operated for switching off and/or triggering a change in direction of a drive device coupled to the closing element.

23. The roll-up door according to claim 22, wherein said safety device includes a photoelectric barrier that is triggered upon deformation of said stabilizing element.

24. The roll-up door according to claim 14, wherein the stabilizing element has a sealing lip which projects downward and forward at an oblique angle, the sealing lip configured to contact a floor when each of the at least one closing element is in the closed position.

25. The roll-up door according to claim 14, wherein the stabilizing element has a multi-part design, and comprises a channel passing through one of the parts.

26. The roll-up door according to claim 14, wherein at least a lower edge of the at least one closing element includes a web-like hanging element coupled to said stabilizing element.

27. A roll-up door system, comprising:
a closing element;
at least one guide element situated on a lateral edge of the closing element; and
an intake system situated on an upper edge of the guide element configured to introduce the lateral edge of the closing element into the guide element during a closing motion, the intake system having at least two oppositely situated delimiting surfaces for the closing element, and/or pretensioning devices selectively contacted with a stabilizing element situated on the lower edge of the closing element, configured to push the closing element in at least one direction opposite to and transverse to a direction of motion of the closing element.

28. The roll-up door according to claim 27, wherein at least one of the pretensioning devices has a bristle element configured to be elastically deflected by the closing element or stabilizing element which strikes it.

29. The roll-up door according to claim 27, wherein the closing element further comprises a lower edge having a strip-like hanging element.

30. The roll-up door according to claim 27, wherein the closing element further comprises a lower edge having a web-like hanging element.

31. A roll-up door, comprising:
at least one closing element, each configured to provide a barrier when the roll-up door is in a closed position;
an elastically deformable stabilizing element coupled to the closing element, the stabilizing element configured to exert a plurality of restoring forces upon deformation; and
a drive mechanism coupled to the at least one closing element and configured to lower the door in a closing direction, and upon receiving a reversal trigger to raise the door in an opening direction.

32. The roll-up door according to claim 31, wherein the stabilizing element is configured to exert a restoring force in a direction opposite to a closing direction to partially counteract deformation of the stabilizing element when the roll-up door is in the closed position.

33. The roll-up door according to claim 32, wherein the stabilizing element is further configured to exert a second stronger restoring force in a direction transverse to the closing element to partially counteract deformation of the stabilizing element when the roll-up door is in the closed position.

34. The roll-up door according to claim 31, further comprising a safety device coupled to the stabilizing element and configured to detect deformation of the stabilization element, and upon deformation, to activate the reversal trigger.

35. The roll-up door according to claim 31, further comprising:
at least one guide element coupled to a lateral edge of the closing element; and
an intake system coupled to an upper edge of the guide element configured to automatically introduce the lateral edge of the closing element into the guide element during a closing motion, the intake system having at least two oppositely situated delimiting surfaces for the closing element, and/or pretensioning devices selectively contacted with a stabilizing element situated on the lower edge of the closing element, configured to push the closing element in at least one direction opposite to and transverse to a direction of motion of the closing element.

36. The roll-up door according to claim 31, wherein the stabilizing element includes a sealing lip configured to provide sealing contact with a surface when the roll-up door is in the closed position.

37. The roll-up door according to claim 31, wherein the stabilizing element comprises a channel running in a longitudinal direction along the stabilizing element and the roll-up door further comprises a safety device accommodated within the channel of the stabilizing element to detect deformation of the stabilization element, the safety device configured to alter the current state of the drive mechanism.
